(19) United States
(12) Patent Application Publication
(10) Pub. No.: US 2026/0186356 A1
(43) Pub. Date: Jul. 2, 2026

(54) DISPLAY DEVICE

(71) Applicant: AUO Corporation, Hsinchu City (TW)

(72) Inventors: Teng-Wei Huang, Hsinchu City (TW); Mei-Lien Huang, Hsinchu City (TW); Chia-Bin Hsiao, Hsinchu City (TW)

(73) Assignee: AUO Corporation, Hsinchu City (TW)

(21) Appl. No.: 19/214,050

(22) Filed: May 21, 2025

(30) Foreign Application Priority Data
Dec. 27, 2024 (TW) 113151335

(51) Int. Cl. G02F 1/1362; G02F 1/1368

(52) U.S. Cl. CPC G02F 1/136209; G02F 1/136222; G02F 1/136286; G02F 1/1368

(57) ABSTRACT

A display device includes a pixel array substrate, a color filter substrate, and a camera module. The pixel array substrate includes multiple scan lines, multiple data lines, multiple display area sub-pixels, and multiple camera area sub-pixels. The color filter substrate includes a first filter area overlapping with the camera area and a second filter area overlapping with the display area. The color filter substrate includes multiple scan line shielding structures and a sub-pixel separation structure. The scan line shielding structures overlap with the scan lines. The sub-pixel separation structure overlaps with the data lines and includes a first light shielding portion and a second light shielding portion arranged in a first direction. Transmittance of the scan line shielding structure for visible light is different from transmittance of the second light shielding portion for visible light.

### CROSS-REFERENCE TO RELATED APPLICATION

This application claims the priority benefit of Taiwan application serial no. 113151335, filed on Dec. 27, 2024. The entirety of the above-mentioned patent application is hereby incorporated by reference herein and made a part of this specification.

### BACKGROUND

### Technical Field

The disclosure relates to a display device.

### Description of Related Art

Under-display camera technology is a technology that hides a camera module under a display screen. Through the transparent or translucent design of a specific region, light rays are allowed to pass through the display screen into the camera module for shooting while maintaining the display effect of the display screen. Such a technology combines optical design, material science, and image processing technology to implement a hole-free full-screen appearance, improving the aesthetics of the device and the user experience.

### SUMMARY

The disclosure provides a display device, which can effectively improve the negative impact on an under-display camera image caused by diffraction.

At least one embodiment of the disclosure provides a display device including a pixel array substrate, a color filter substrate, and a camera module. The pixel array substrate has a display area and a camera area, and includes multiple scan lines, multiple data lines, multiple display area sub-pixels located in the display area, and multiple camera area sub-pixels located in the camera area. The scan lines extend along a first direction. The data lines extend along a second direction not parallel to the first direction. The color filter substrate includes a first filter area overlapping with the camera area and a second filter area overlapping with the display area. The color filter substrate includes multiple scan line shielding structures and a sub-pixel separation structure located in the first filter area. The scan line shielding structures overlap with the scan lines. The sub-pixel separation structure overlaps with the data lines and includes a first light shielding portion and a second light shielding portion arranged in the first direction. Transmittance of the scan line shielding structures for visible light is different from transmittance of the second light shielding portion for visible light. The camera area is located between the camera module and the first filter area.

At least one embodiment of the disclosure provides a display device including a pixel array substrate, a color filter substrate, and a camera module. The pixel array substrate has a display area and a camera area, and includes multiple scan lines, multiple data lines, multiple display area sub-pixels, and multiple camera area sub-pixels. The scan lines extend along a first direction. The data lines extend along a second direction not parallel to the first direction. The display area sub-pixels are located in the display area. The camera area sub-pixels are located in the camera area. The color filter substrate includes a first filter area overlapping with the camera area and a second filter area overlapping with the display area, and includes multiple scan line shielding structures and a sub-pixel separation structure located in the first filter area and a black matrix located in the second filter area. The scan line shielding structures overlap with the scan lines. The sub-pixel separation structure overlaps with the data lines. The sub-pixel separation structure includes multiple first light shielding portions and multiple second light shielding portions arranged in an array in the first direction and the second direction. A width of each of the first light shielding portions in the first direction is different from a width of each of the second light shielding portions in the first direction. The black matrix overlaps with the scan lines and the data lines in the display area. The camera area is located between the camera module and the first filter area.

### BRIEF DESCRIPTION OF THE DRAWINGS

FIG. 1 is an exploded view of a display device according to an embodiment of the disclosure.

FIG. 2A is a partially enlarged top perspective view of a pixel array substrate of the display device of FIG. 1.

FIG. 2B is a partially enlarged top perspective view of a color filter substrate of the display device of FIG. 1.

FIG. 3A is a cross-sectional schematic view along lines A-A′ and B-B′ of FIG. 2A and FIG. 2B.

FIG. 3B is a cross-sectional schematic view along lines C-C′ and D-D′ of FIG. 2A and FIG. 2B.

FIG. 4 shows a relationship graph between wavelength and transmittance of light rays of a red light filter pattern, a green light filter pattern, a blue light filter pattern, and an infrared light filter pattern in some embodiments.

FIG. 5 is a cross-sectional schematic view of a display device according to an embodiment of the disclosure.

FIG. 6A and FIG. 6B are schematic views of the display device applied in a vehicle according to an embodiment of the disclosure.

FIG. 7 is a cross-sectional schematic view of a display device according to an embodiment of the disclosure.

FIG. 8A is a partially enlarged top perspective view of a color filter substrate of a display device according to an embodiment of the disclosure.

FIG. 8B is a cross-sectional schematic view along a line F-F′ of FIG. 8A.

FIG. 9 is a partially enlarged top perspective view of a color filter substrate of a display device according to an embodiment of the disclosure.

FIG. 10 is a partially enlarged top perspective view of a color filter substrate of a display device according to an embodiment of the disclosure.

FIG. 11 is an exploded view of a display device according to an embodiment of the disclosure.

FIG. 12 is a cross-sectional schematic view of the display device according to an embodiment of the disclosure.

FIG. 13 is a cross-sectional schematic view of a display device according to an embodiment of the disclosure.

FIG. 14 is a partially enlarged top perspective view of a color filter substrate of a display device according to an embodiment of the disclosure.

FIG. 15 is a cross-sectional schematic view of a color filter substrate of a display device according to an embodiment of the disclosure.

FIG. 16A is a partially enlarged top perspective view of a color filter substrate of a display device according to an embodiment of the disclosure.

FIG. 16B is a cross-sectional schematic view of the color filter substrate of FIG. 16A and the second polarizing plate and a cover plate located thereon.

FIG. 17A is a partially enlarged top perspective view of a color filter substrate of a display device according to an embodiment of the disclosure.

FIG. 17B is a cross-sectional schematic view of the color filter substrate of FIG. 17A and a second polarizing plate and a cover plate located thereon.

FIG. 18A is a partially enlarged top perspective view of a color filter substrate of a display device according to an embodiment of the disclosure.

FIG. 18B is a cross-sectional schematic view of the color filter substrate of FIG. 18A and a second polarizing plate and a cover plate located thereon.

FIG. 19 is a partially enlarged top perspective view of a color filter substrate of a display device according to an embodiment of the disclosure.

FIG. 20A is a partially enlarged top perspective view of a display device according to an embodiment of the disclosure.

FIG. 20B is a cross-sectional schematic view along lines A-A′ and B-B′ of FIG. 20A.

FIG. 21 is a partially enlarged top perspective view of a color filter substrate of a display device according to an embodiment of the disclosure.

### DESCRIPTION OF THE EMBODIMENTS

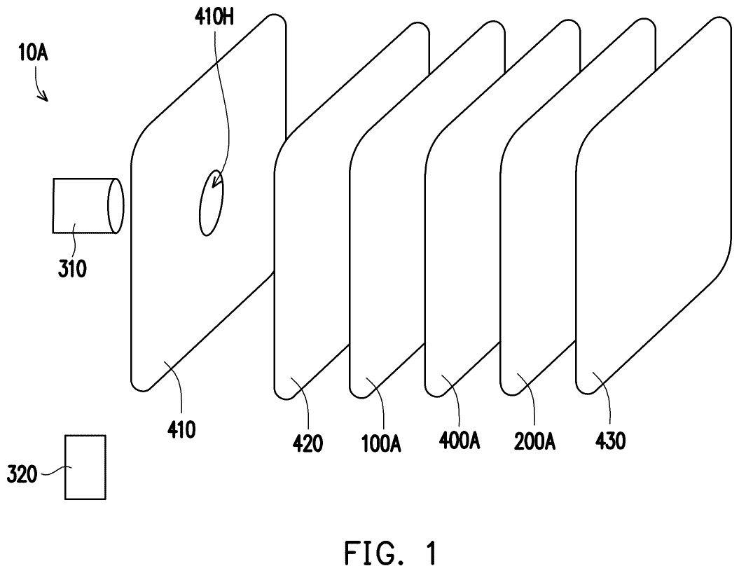

FIG. 1 is an exploded view of a display device 10A according to an embodiment of the disclosure. Please refer to FIG. 1. In the embodiment, the display device 10A includes a pixel array substrate 100A, a color filter substrate 200A, and a camera module 310. In the embodiment, the display device 10A includes a liquid crystal display device and further includes a liquid crystal layer 400A, a backlight module 410, a first polarizing plate 420, and a second polarizing plate 430.

The pixel array substrate 100A overlaps with the color filter substrate 200A. The liquid crystal layer 400A is located between the pixel array substrate 100A and the color filter substrate 200A. The first polarizing plate 420 and the second polarizing plate 430 are respectively located on the pixel array substrate 100A and the color filter substrate 200A. The backlight module 410 is located on a back side of the pixel array substrate 100A and has a via 410H. The camera module 310 overlaps with the via 410H, so that the backlight module 410 does not shield light rays that the camera module 310 intends to receive.

In some embodiments, the camera module 310 includes an infrared light sensing element. In sunlight, infrared light with a wavelength of about 940 nm is easily absorbed by water vapor in the air and has low radiation energy. Therefore, the use of the infrared light sensing element may reduce the interference of ambient light on an image. In addition, the polarizing plate has high transmittance for infrared light and is not easy to cause infrared light to produce polarization characteristics. Therefore, the use of the infrared light sensing element may reduce the interference of screen switching of the liquid crystal display device on the camera module 310.

In some embodiments, when the camera module 310 includes the infrared light sensing element, an infrared light source 320 may be optionally included in the display device 10A. In some embodiments, the infrared light source 320 may be disposed in the backlight module 410 or outside the liquid crystal display device. The disclosure does not particularly limit the position of the infrared light source 320.

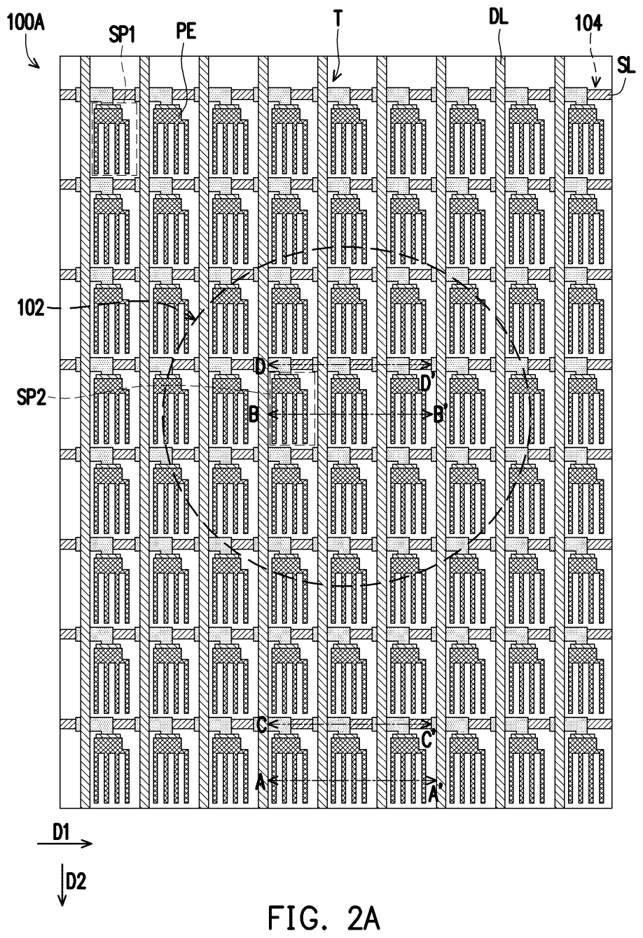

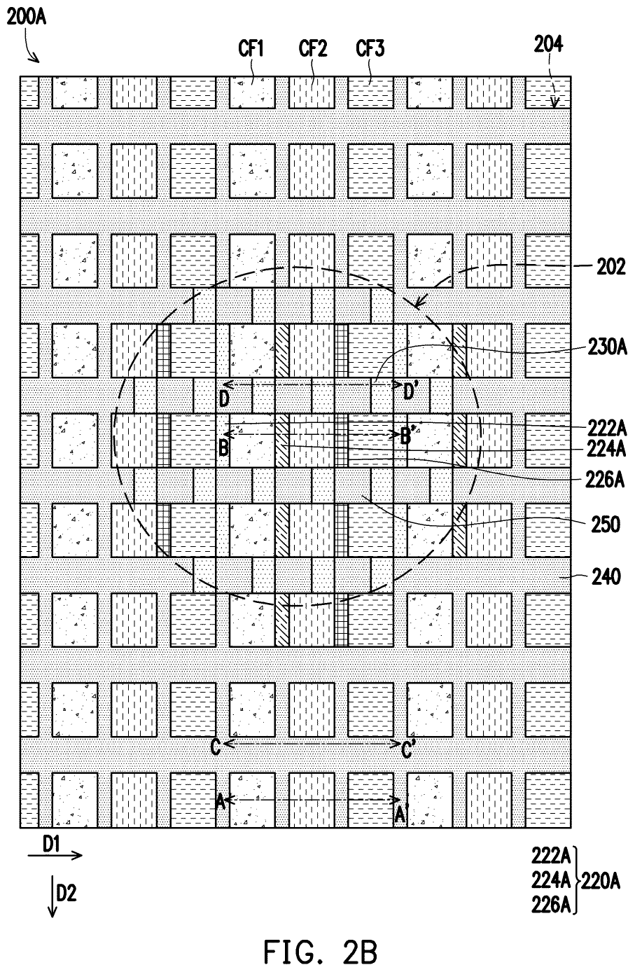

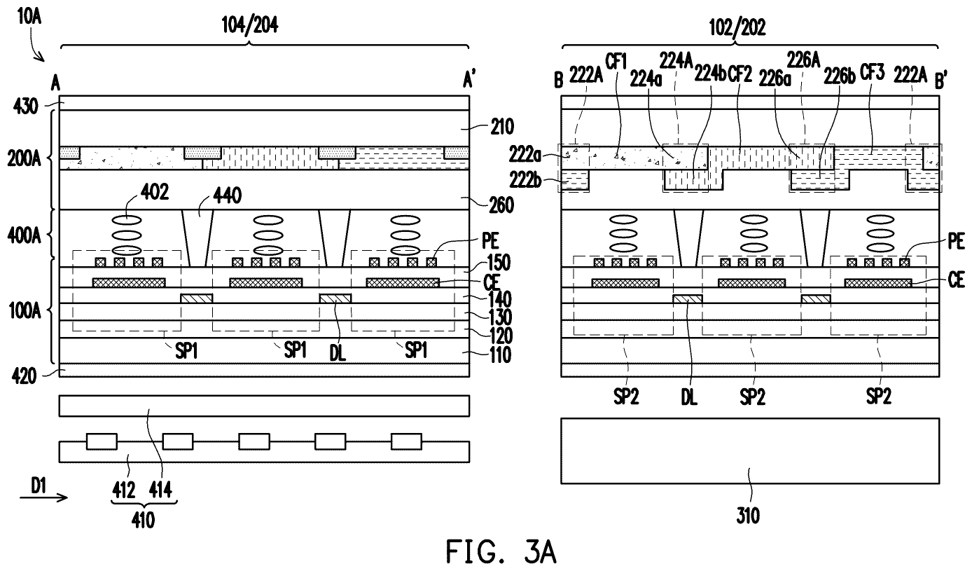

FIG. 2A is a partially enlarged top perspective view of the pixel array substrate 100A of the display device 10A of FIG. 1. FIG. 2B is a partially enlarged top perspective view of a color filter substrate 200A of the display device 10A of FIG. 1. FIG. 3A is a cross-sectional schematic view along lines A-A′ and B-B′ of FIG. 2A and FIG. 2B. FIG. 3B is a cross-sectional schematic view along lines C-C′ and D-D′ of FIG. 2A and FIG. 2B. Please refer to FIG. 2A, FIG. 3A, and FIG. 3B. In the embodiment, the backlight module 410 is a direct-type backlight module and includes a light board 412 and one or more optical films 414, but the disclosure is not limited thereto. Other types of backlight modules may also be applicable to the disclosure, such as an edge-type backlight module.

The pixel array substrate 100A has a camera area 102 and a display area 104. The display area 104 is located on at least one side of the camera area 102. In the embodiment, the display area 104 surrounds the camera area 102. The shape of the camera area 102 is, for example, a circle, a square, an ellipse, a rectangle, or other geometric shapes. The camera area 102 overlaps with the camera module 310. The display area 104 overlaps with the backlight module 410. In the embodiment, the display area 104 and the camera area 102 may be both used to display images.

The pixel array substrate 100A includes a first substrate 110, insulating layers 120, 130, 140, and 150, multiple scan lines SL, multiple data lines DL, multiple display area sub-pixels SP1 located in the display area 104, and multiple camera area sub-pixels SP2 located in the camera area 102. In some embodiments, each of the display area sub-pixels SP1 and the camera area sub-pixels SP2 includes an active element T and a pixel electrode PE electrically connected thereto. In some embodiments, the number of the insulating layers 120, 130, 140, and 150 may be adjusted according to requirements.

The scan lines SL are located on the first substrate 110 and extend along a first direction D1, and at least part of the scan lines SL extend from the display area 104 to the camera area 102. In some embodiments, a gate of the active element T is integrated with the scan line SL.

The insulating layer 120 is located on the scan line SL. A semiconductor layer SM of the active element T is located on the insulating layer 120 and overlaps with the gate. The insulating layer 130 is located on the semiconductor layer SM.

The data lines DL are located on the insulating layer 130 and extend along a second direction D2 that is not parallel to the first direction D1, and at least part of the data lines DL extend from the display area 104 to the camera area 102. In some embodiments, a first source/drain of the active element T is integrated with the data line DL, and a second source/drain is separated from the data line DL. The first source/drain and the second source/drain of the active element T are electrically connected to the semiconductor layer SM.

In the embodiment, the active element T includes a bottom-gate thin film transistor as an example, but the disclosure is not limited thereto. In other embodiments, the active element T includes a top-gate thin film transistor, a dual-gate thin film transistor, or other types of thin film transistors.

The insulating layer 140 is located on the data line DL. A common electrode CE is located on the insulating layer 140. In the embodiment, the pixel array substrate 100A includes the common electrode CE, but the disclosure is not limited thereto. In other embodiments, the common electrode CE is disposed in the color filter substrate 200A. In other words, the color filter substrate 200A includes the common electrode CE.

The insulating layer 150 is located on the common electrode CE. The pixel electrode PE is located on the insulating layer 150 and overlaps with the common electrode CE. A liquid crystal molecule 402 in the liquid crystal layer 400A may be controlled through an electric field between the pixel electrode PE and the common electrode CE. In some embodiments, the pixel electrode PE further includes a liquid crystal alignment layer (not shown), but the disclosure is not limited thereto.

Please refer to FIG. 2B, FIG. 3A, and FIG. 3B. The color filter substrate 200A has a first filter area 202 and a second filter area 204. The second filter area 204 is located on at least one side of the first filter area 202. In the embodiment, the second filter area 204 surrounds the first filter area 202. The shape of the first filter area 202 is, for example, a circle, a square, an ellipse, a rectangle, or other geometric shapes. The first filter area 202 overlaps with the camera module 310. The camera area 102 of the pixel array substrate 100A is located between the camera module 310 and the first filter area 202 of the color filter substrate 200A. The second filter area 204 overlaps with the backlight module 410.

The color filter substrate 200A includes a second substrate 210, multiple scan line shielding structures 230A located in the first filter area 202, a sub-pixel separation structure 220A located in the first filter area 202, and a black matrix 240 located in the second filter area 204. The black matrix 240 overlaps with the scan line SL and the data line DL in the display area 104 of the pixel array substrate 100A (please refer to FIG. 2A), and the scan line shielding structure 230A and the sub-pixel separation structure 220A overlap with the scan line SL and the data line DL in the camera area 102 of the pixel array substrate 100A.

In the embodiment, the color filter substrate 200A includes a first color filter pattern CF1, a second color filter pattern CF2, and a third color filter pattern CF3 located on the second substrate 210, wherein the first color filter pattern CF1, the second color filter pattern CF2, and the third color filter pattern CF3 are filter patterns of different colors, and the scan line shielding structure 230A, the sub-pixel separation structure 220A, and the black matrix 240 are used to separate filter patterns corresponding to different sub-pixels. In some embodiments, the first color filter pattern CF1, the second color filter pattern CF2, and the third color filter pattern CF3 are respectively a red filter pattern, a green filter pattern, and a blue filter pattern.

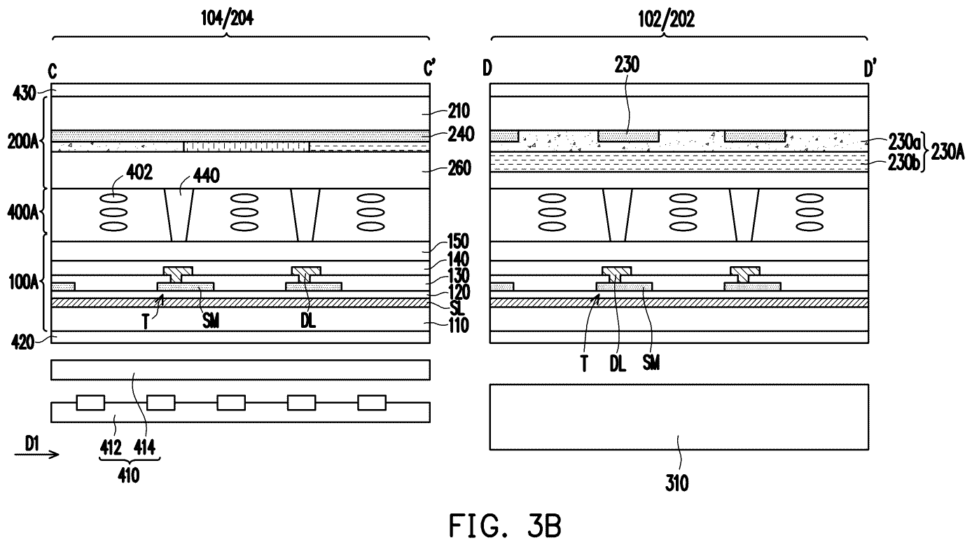

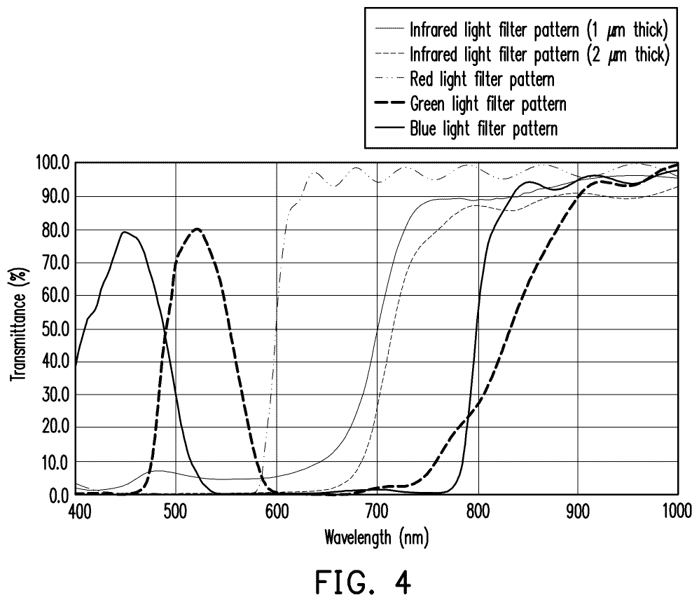

The scan line shielding structure 230A extends along the first direction D1 and overlaps with the scan line SL (please refer to FIG. 2A). Please refer to FIG. 3B. In the embodiment, each scan line shielding structure 230A includes a first filter layer 230a and a second filter layer 230b overlapping with the first filter layer 230a. One of the first filter layer 230a and the second filter layer 230b has the same material as and is integrally connected to the first color filter pattern CF1, and the other one has the same material as and is integrally connected to the third color filter pattern CF3. In some embodiments, the first filter layer 230a and the second filter layer 230b respectively have the same material as the red filter pattern and the blue filter pattern. FIG. 4 shows a relationship graph between wavelength and transmittance of light rays of a red light filter pattern, a green light filter pattern, a blue light filter pattern, and an infrared light filter pattern in some embodiments. In the wavelength range of visible light, wavelength ranges of main transmission light of the red filter pattern and the blue filter pattern do not overlap, so the scan line shielding structure 230A formed by stacking the materials of the red filter pattern and the blue filter pattern may effectively shield visible light. In addition, it can be seen from FIG. 4 that infrared light (with a wavelength of, for example, about 940 nm) has a very high transmittance (for example, a transmittance of more than 90%) for the red filter pattern, the green filter pattern, and the blue filter pattern. Therefore, using the material of the red filter pattern and the material of the blue filter pattern as the scan line shielding structure 230A, diffraction of infrared light in the first filter area 202 may be reduced.

Returning to FIG. 2B, FIG. 3A, and FIG. 3B, in some embodiments, the color filter substrate 200A may optionally include multiple light shielding layers 250. The light shielding layers 250 are separated from each other and overlap with the semiconductor layer SM in the pixel array substrate 100A to prevent the active element T from light leakage or electrical degradation due to being irradiated by infrared light. In some embodiments, the light shielding layer 250 and the black matrix 240 are each a single layer of a black light absorbing material and include the same material. In some embodiments, the light shielding layer 250 and the black matrix 240 include the same material, and the transmittance of the scan line shielding structure 230A for infrared light is greater than the transmittance of the light shielding layer 250 and the black matrix 240 for infrared light. In some embodiments, the materials of the light shielding layer 250 and the black matrix 240 include black pigment, black dye, black resin, black metal, metal oxide, or other suitable light absorbing materials.

The sub-pixel separation structure 220A overlaps with the data line DL (please refer to FIG. 2A) and includes a first light shielding portion 222A, a second light shielding portion 224A, and a third light shielding portion 226A arranged in the first direction D1.

The first light shielding portion 222A is located between the first color filter pattern CF1 and the third color filter pattern CF3 in the first direction D1, the second light shielding portion 224A is located between the first color filter pattern CF1 and the second color filter pattern CF2 in the first direction D1, and the third light shielding portion 226A is located between the second color filter pattern CF2 and the third color filter pattern CF3 in the first direction D1.

In the embodiment, the first light shielding portion 222A includes a first bottom layer 222a and a first cover layer 222b. The first cover layer 222b overlaps with the first bottom layer 222a. One of the first bottom layer 222a and the first cover layer 222b has the same material as and is integrally connected to the first color filter pattern CF1, and the other one has the same material as and is integrally connected to the third color filter pattern CF3. In some embodiments, the first light shielding portion 222A and the scan line shielding structure 230A have the same material. In other words, the first light shielding portion 222A and the scan line shielding structure 230A have the same transmittance for visible light, and the first light shielding portion 222A and the scan line shielding structure 230A have the same transmittance for infrared light.

The second light shielding portion 224A includes a second bottom layer 224a and a second cover layer 224b. The second cover layer 224b overlaps with the second bottom layer 224a. One of the second bottom layer 224a and the second cover layer 224b has the same material as and is integrally connected to the first color filter pattern CF1, and the other one has the same material as and is integrally connected to the second color filter pattern CF2. The transmittance of the scan line shielding structure 230A and the first light shielding portion 222A for visible light is different from the transmittance of the second light shielding portion 224A for visible light. In some embodiments, the transmittance of the scan line shielding structure 230A and the first light shielding portion 222A for infrared light is the same as or different from the transmittance of the second light shielding portion 224A for infrared light.

The third light shielding portion 226A includes a third bottom layer 226a and a third cover layer 226b. The third cover layer 226b overlaps with the third bottom layer 226a. One of the third bottom layer 226a and the third cover layer 226b has the same material as and is integrally connected to the second color filter pattern CF2, and the other one has the same material as and is integrally connected to the third color filter pattern CF3. The transmittance of the scan line shielding structure 230A and the first light shielding portion 222A for visible light is different from the transmittance of the third light shielding portion 226A for visible light. In some embodiments, the transmittance of the scan line shielding structure 230A and the first light shielding portion 222A for infrared light is the same as or different from the transmittance of the third light shielding portion 226A for infrared light.

In the embodiment, the transmittance of the first light shielding portion 222A, the second light shielding portion 224A, and the third light shielding portion 226A for infrared light is all greater than the transmittance of the light shielding layer 250 and the black matrix 240 for infrared light. Therefore, diffraction of infrared light in the first filter area 202 may be reduced.

A protective layer 260 covers the first color filter pattern CF1, the second color filter pattern CF2, the third color filter pattern CF3, the scan line shielding structure 230A, and the sub-pixel separation structure 220A.

In the embodiment, a spacer 440 is optionally included between the color filter substrate 200A and the pixel array substrate 100A. The spacer 440 helps to control the thickness of the liquid crystal layer 400A between the color filter substrate 200A and the pixel array substrate 100A.

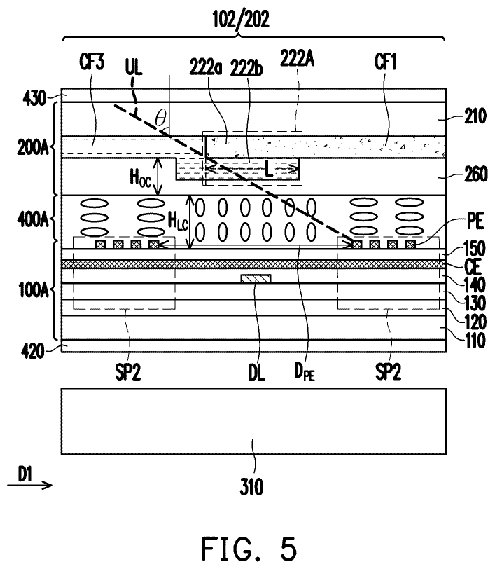

FIG. 5 is a cross-sectional schematic view of a display device according to an embodiment of the disclosure. It must be noted here that the embodiment of FIG. 5 continues to use the reference numerals and some content of the embodiment of FIG. 1 to FIG. 3B, wherein the same or similar numerals are adopted to represent the same or similar elements, and the description of the same technical content is omitted. Reference may be made to the aforementioned embodiment for the description of the omitted part, which will not be reiterated here.

Please refer to FIG. 5. The thickness of the liquid crystal layer 400A is H_{LC}. The thickness of the protective layer 260 is H_{OC}. The distance between the pixel electrodes PE of two adjacent camera area sub-pixels SP2 is D_{PE}. The width of the first light shielding portion 222A in the first direction D1 is L, and the included angle between a shortest virtual line UL between the pixel electrode PE of one of the camera area sub-pixels SP2 located below the first color filter pattern CF1 and a side wall of the first bottom layer 222a and a normal line direction of a top surface of the first bottom layer 222a is θ.

In some embodiments, the width L satisfies Mathematical expression 1.

$$L > 2 \times ( {H}_{OC} + {H}_{LC} ) \times tan θ - {D}_{PE} \qquad ( Mathematical expression 1 )$$

By making the width L satisfy Mathematical expression 1, color mixing or color shift caused by light rays of sub-pixels on two sides of the first light shielding portion 222A interfering with each other may be prevented.

In some embodiments, the width L satisfies Mathematical expression 2.

$$( Mathematical expression 2 )$$

$$2 \times ( {H}_{OC} + {H}_{LC} ) \times tan 60 ° - {D}_{PE} > L > 2 \times ( {H}_{OC} + {H}_{LC} ) \times tan 40 ° - {D}_{PE}$$

By making the width L satisfy Mathematical expression 2, color mixing or color shift that occurs within the viewing angle of 40° to 60° may be prevented.

In some embodiments, the width L of the second light shielding portion 224A (please refer to FIG. 3A and FIG. 3B) and the width L of the third light shielding portion 226A (please refer to FIG. 3A and FIG. 3B) are equal to the width L of the first light shielding portion 222A.

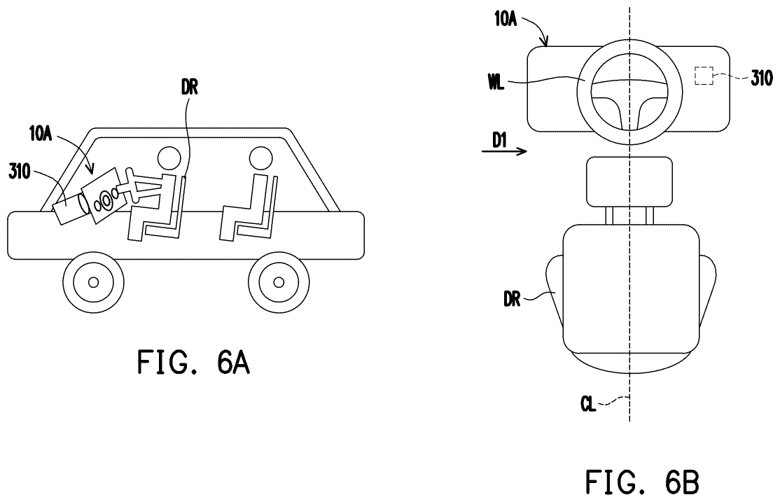

FIG. 6A and FIG. 6B are schematic views of the display device 10A applied in a vehicle according to an embodiment of the disclosure. Please refer to FIG. 6A and FIG. 6B. The display device 10A may be applied in the vehicle and may be, for example, used as a dashboard. In some embodiments, the camera module 310 in the display device 10A may be used to monitor a driver in a driver seat DR to improve driving safety. For example, the camera module 310 may be used to identify features such as the sclera and the eyeballs of the driver and can detect and issue a warning notification in real time when the driver appears to be in a drowsy state.

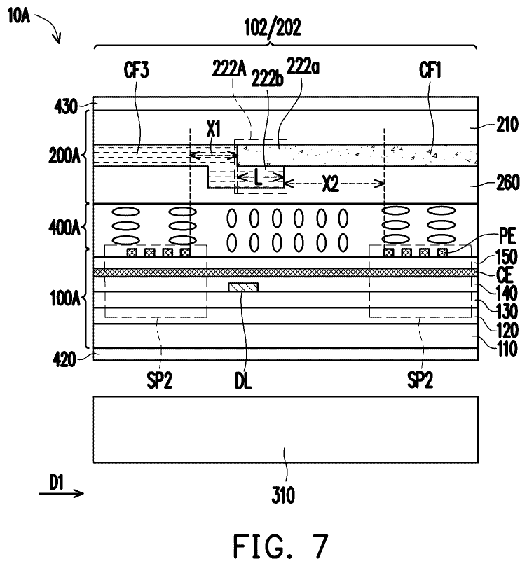

FIG. 7 is a cross-sectional schematic view of a display device according to an embodiment of the disclosure. Please refer to FIG. 6B and FIG. 7. Since the center of the camera module 310 may not be aligned with a center line CL of the driver seat DR, the first light shielding portion 222A, the second light shielding portion, and the third light shielding portion in the color filter substrate 200A may be designed to deviate from the center of the line connecting the adjacent camera area sub-pixels SP2. FIG. 7 takes the first light shielding portion 222A as an example for illustration. Please refer to FIG. 7. The pixel electrode PE of the camera area sub-pixel SP2 located below the first color filter pattern CF1 and the first cover layer 222b are separated by a distance X2 in the first direction D1. The pixel electrode PE of the camera area sub-pixel SP2 located below the third color filter pattern CF3 and the first bottom layer 222a are separated by a distance X1 in the first direction D1. The distance X1 is not equal to the distance X2.

Please refer to FIG. 6B and FIG. 7 at the same time. In the embodiment, the camera module 310 is located on the right side of the center line CL of the steering wheel WL and/or the driver seat DR, and the distance X2 is greater than the distance X1. In other embodiments, the camera module 310 is located on the left side of the center line CL of the steering wheel WL and/or the driver seat DR, and the distance X2 is less than the distance X1.

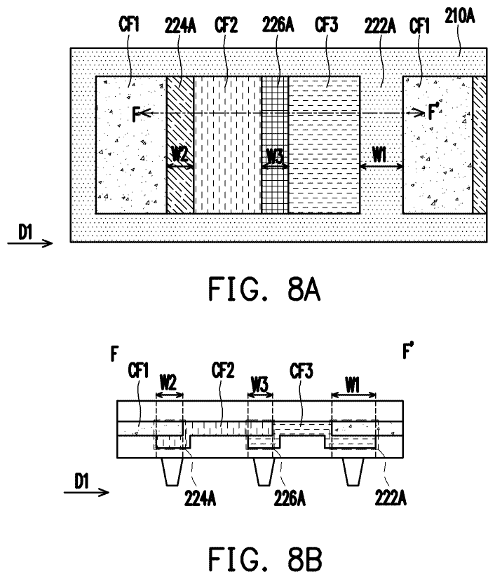

FIG. 8A is a partially enlarged top perspective view of a color filter substrate of a display device according to an embodiment of the disclosure. FIG. 8B is a cross-sectional schematic view along a line F-F′ of FIG. 8A. It must be noted here that the embodiment of FIG. 8A and FIG. 8B continues to use the reference numerals and some content of the embodiment of FIG. 1 to FIG. 3B, wherein the same or similar numerals are adopted to represent the same or similar elements, and the description of the same technical content is omitted. Reference may be made to the aforementioned embodiment for the description of the omitted part, which will not be reiterated here. Please refer to FIG. 8A and FIG. 8B. In the embodiment, a width W2 of the second light shielding portion 224A in the first direction D1 and a width W3 of the third light shielding portion 226A in the first direction D1 are less than the width W1 of the first light shielding portion 222A in the first direction D1.

By adjusting the width W1 of the first light shielding portion 222A, the shape of a light emitting area and the periodicity of a sub-pixel may be changed, thereby reducing occurrence of diffraction. Since the sensitivity of human eyes to red light and blue light is lower than that to green light, changing the first light shielding portion 222A composed of a blue filter material and a red filter material has little effect on a display image of the camera area.

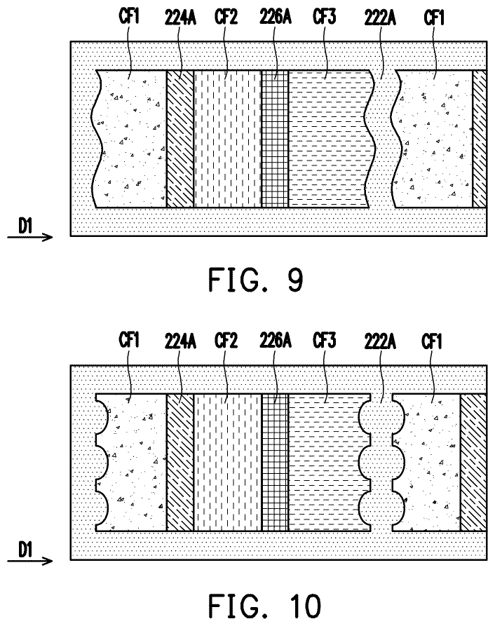

In the embodiment, the first light shielding portion 222A is in a strip shape, but the disclosure is not limited thereto. In other embodiments, the first light shielding portion 222A has a wavy edge, as shown in FIG. 9 and FIG. 10.

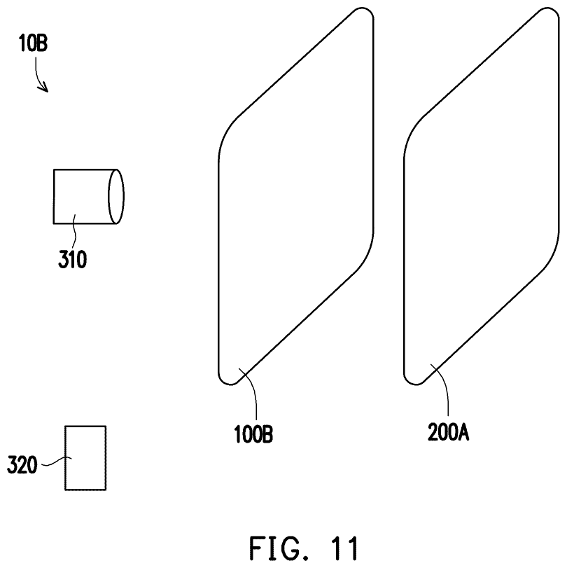

FIG. 11 is an exploded view of a display device 10B according to an embodiment of the disclosure. It must be noted here that the embodiment of FIG. 11 continues to use the reference numerals and some content of the embodiment of FIG. 1 to FIG. 3B, wherein the same or similar numerals are adopted to represent the same or similar elements, and the description of the same technical content is omitted. Reference may be made to the aforementioned embodiment for the description of the omitted part, which will not be reiterated here.

Please refer to FIG. 11. In the embodiment, the display device 10B includes a pixel array substrate 100B, the color filter substrate 200A, and the camera module 310. In the embodiment, the display device 10B includes a micro light emitting diode display device.

In some embodiments, when the camera module 310 includes an infrared light sensing element, the infrared light source 320 may be optionally included in the display device 10B. In some embodiments, the infrared light source 320 may be disposed on the pixel array substrate 100B or outside the micro light emitting diode display device. The disclosure does not particularly limit the position of the infrared light source 320.

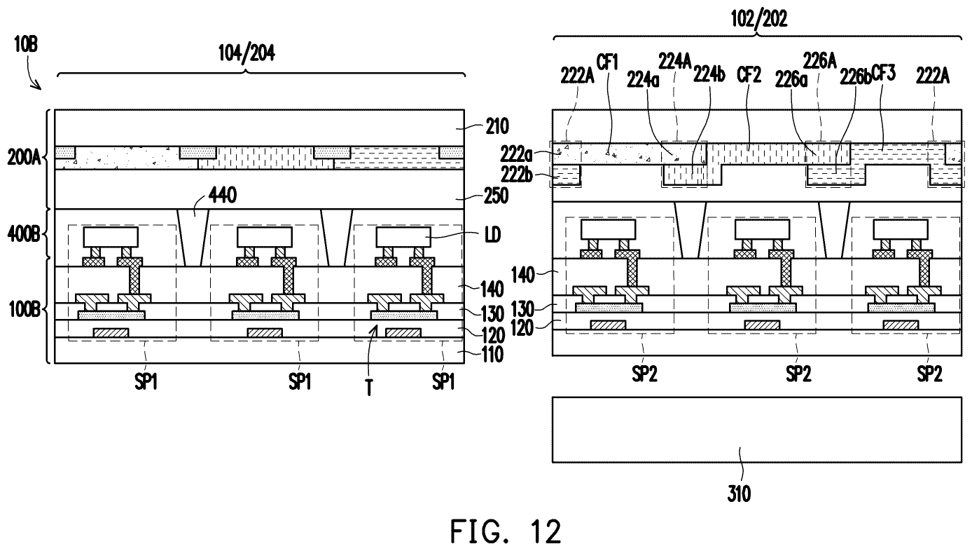

FIG. 12 is a cross-sectional schematic view of the display device 10B according to an embodiment of the disclosure. Please refer to FIG. 12. The pixel array substrate 100B includes the first substrate 110, the insulating layers 120, 130, and 140, multiple scan lines (not shown separately in FIG. 12), multiple data lines (not shown separately in FIG. 12), the display area sub-pixels SP1 located in the display area 104, and the camera area sub-pixels SP2 located in the camera area 102. In some embodiments, each of the display area sub-pixel SP1 and the camera area sub-pixel SP2 includes the active element T and a micro light emitting diode LD electrically connected thereto. In some embodiments, the number of the insulating layers 120, 130, and 140 may be adjusted according to requirements.

In the embodiment, the color filter substrate 200A is attached to the pixel array substrate 100B through a packaging adhesive 400B, and the packaging adhesive 400B encapsulates the micro light emitting diode LD.

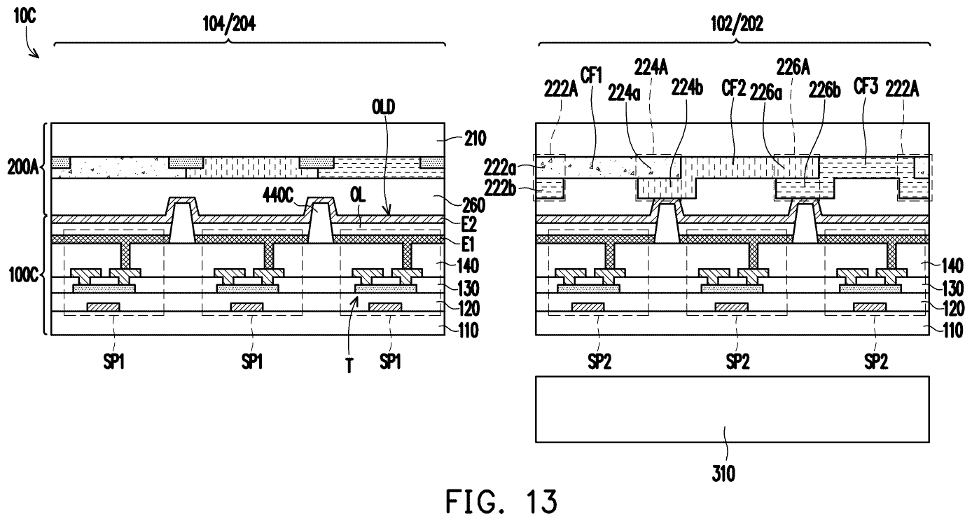

FIG. 13 is a cross-sectional schematic view of a display device 10C according to an embodiment of the disclosure. Please refer to FIG. 13. A pixel array substrate 100C includes the first substrate 110, the insulating layers 120, 130, and 140, multiple scan lines (not shown separately in FIG. 13), multiple data lines (not shown separately in FIG. 13), the display area sub-pixels SP1 located in the display area 104, and the camera area sub-pixels SP2 located in the camera area 102. In some embodiments, each of the display area sub-pixel SP1 and the camera area sub-pixel SP2 includes the active element T and an organic light emitting diode OLD electrically connected thereto. In some embodiments, the number of the insulating layers 120, 130, and 140 may be adjusted according to requirements.

The organic light emitting diode OLD includes a first electrode E1, a second electrode E2, and an organic light emitting layer OL located therebetween. The first electrode E1 is electrically connected to the active element T. The second electrode E2 is a common electrode.

In the embodiment, the color filter substrate 200A is attached to the pixel array substrate 100C. In some embodiments, an adhesive layer (not shown) is included between the color filter substrate 200A and the pixel array substrate 100C.

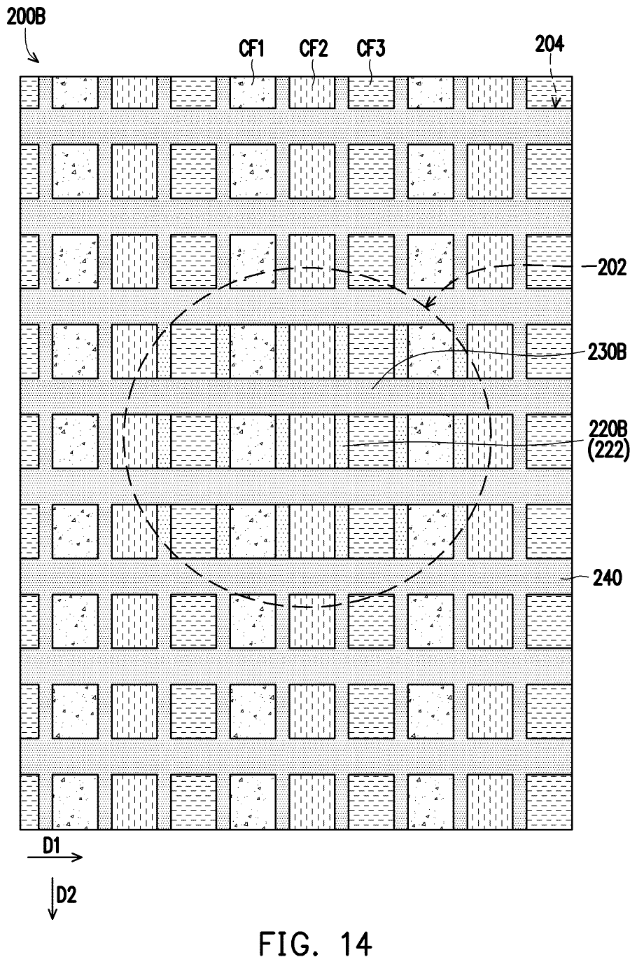

FIG. 14 is a partially enlarged top perspective view of a color filter substrate of a display device according to an embodiment of the disclosure. It must be noted here that the embodiment of FIG. 14 continues to use the reference numerals and some content of the embodiment of FIG. 1 to FIG. 3B, wherein the same or similar numerals are adopted to represent the same or similar elements, and the description of the same technical content is omitted. Reference may be made to the aforementioned embodiment for the description of the omitted part, which will not be reiterated here.

Please refer to FIG. 14. A color filter substrate 200B has the first filter area 202 and the second filter area 204. The second filter area 204 is located on at least one side of the first filter area 202.

The color filter substrate 200B includes multiple scan line shielding structures 230B located in the first filter area 202, a sub-pixel separation structure 220B located in the first filter area 202, and the black matrix 240 located in the second filter area 204. The black matrix 240 overlaps with the scan line SL and the data line DL (please refer to FIG. 2A) in the display area 104, and the scan line shielding structure 230B and the sub-pixel separation structure 220B overlap with the scan line SL and the data line DL in the camera area 102.

In the embodiment, the color filter substrate 200B includes the first color filter pattern CF1, the second color filter pattern CF2, and the third color filter pattern CF3 located on the second substrate, wherein the first color filter pattern CF1, the second color filter pattern CF2, and the third color filter pattern CF3 are filter patterns of different colors, and the scan line shielding structure 230B, the sub-pixel separation structure 220B, and the black matrix 240 are used to separate the filter patterns corresponding to different sub-pixels. In some embodiments, the first color filter pattern CF1, the second color filter pattern CF2, and the third color filter pattern CF3 are respectively a red filter pattern, a green filter pattern, and a blue filter pattern.

The scan line shielding structure 230B extends along the first direction D1 and overlaps with the scan line SL (please refer to FIG. 2A). In some embodiments, the scan line shielding structure 230B and the black matrix 240 include the same material. For example, the scan line shielding structure 230B and the black matrix 240 are both a single layer of a black light absorbing material, and the material includes black pigment, black dye, black resin, black metal, metal oxide, or other suitable light absorbing materials.

The sub-pixel separation structure 220B overlaps with the data line DL (please refer to FIG. 2A) and includes multiple light shielding portions 222 arranged in the first direction D1 and the second direction D2. Adjacent light shielding portions 222 in the second direction D2 are separated by the scan line shielding structure 230B.

In the embodiment, each light shielding portion 222 includes the same material. However, the transmittance of the light shielding portion 222 for infrared light is greater than the transmittance of the scan line shielding structure 230B and the black matrix 240 for infrared light, so as to reduce diffraction of infrared light in the first filter area 202. In the embodiment, the light shielding portion 222 includes the infrared light filter pattern. Specifically, most of visible light band is absorbed by the infrared light filter pattern, and most of infrared light may penetrate the infrared light filter pattern. In some embodiments, the infrared light filter pattern has a transmittance of more than 70% for infrared light of 940 nm (please refer to FIG. 4) and a transmittance of less than 15% for visible light with a wavelength of below 700 nm (please refer to FIG. 4). In some embodiments, the transmittance (for example, less than 5%) of the scan line shielding structure 230B and the black matrix 240 for infrared light of 940 nm is lower than that of the infrared light filter pattern. However, the transmittance (for example, 5% to 15%) of the infrared light filter pattern for red light with a wavelength of about 700 nm is higher than the transmittance (for example, less than 5%) of the scan line shielding structure 230B and the black matrix 240 for red light with a wavelength of about 700 nm.

In some embodiments, the transmittance of the infrared light filter pattern for red light with a relatively short wavelength (for example, 620 nm to 650 nm) is lower than the transmittance of the red light filter pattern for red light with a relatively short wavelength (for example, 620 nm to 650 nm).

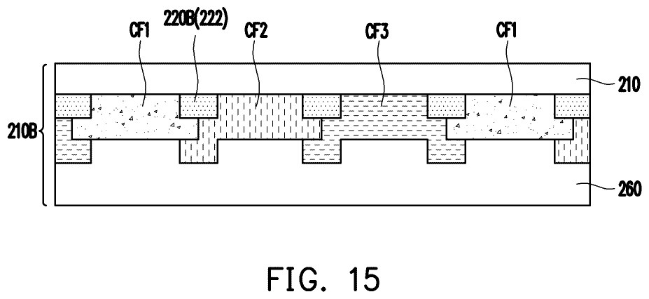

In the embodiment, since a part of red light (for example, red light with a wavelength of about 700 nm) may pass through the light shielding portion 222, in order to prevent red light from penetrating and interfering with green or blue sub-pixels, the second filter pattern CF2 (that is, the green filter pattern) and the third filter pattern CF3 (that is, the blue filter pattern) are extended to a top surface of the first filter pattern CF1 (that is, the color filter pattern), as shown in FIG. 15. Please refer to FIG. 15. A top surface of each light shielding portion 222 overlaps with at least one of the second filter pattern CF2 and the third filter pattern CF3. Red light passing through the light shielding portion 222 may be filtered out by the second filter pattern CF2 and the third filter pattern CF3, reducing occurrence of color shift.

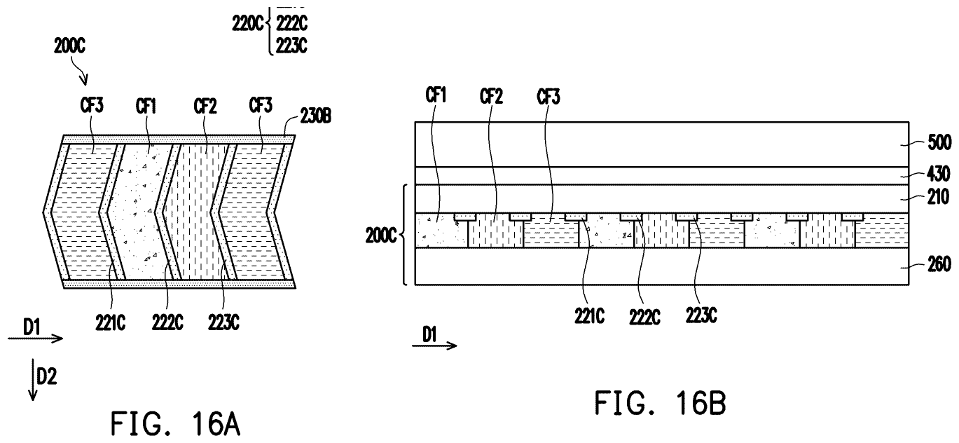

FIG. 16A is a partially enlarged top perspective view of a color filter substrate 200C of a display device according to an embodiment of the disclosure. FIG. 16B is a cross-sectional schematic view of the color filter substrate 200C of FIG. 16A and the second polarizing plate 430 and a cover plate 500 located thereon. It must be noted here that the embodiment of FIG. 16A and FIG. 16B continues to use the reference numerals and some content of the embodiment of FIG. 14, wherein the same or similar numerals are adopted to represent the same or similar elements, and the description of the same technical content is omitted. Reference may be made to the aforementioned embodiment for the description of the omitted part, which will not be reiterated here.

Please refer to FIG. 16A and FIG. 16B. In the embodiment, the data line (not shown) is substantially zigzag. Therefore, a part of the black matrix (not shown) of the color filter substrate 200C for shielding the data line and a sub-pixel separation structure 220C also adopt the zigzag design.

In the embodiment, the sub-pixel separation structure 220C includes a first light shielding portion 221C, a second light shielding portion 222C, and a third light shielding portion 223C. The first light shielding portion 221C, the second light shielding portion 222C, and the third light shielding portion 223C include the same material, for example, all are the infrared light filter pattern. The first light shielding portion 221C is located between the first filter pattern CF1 and the third filter pattern CF3, the second light shielding portion 222C is located between the first filter pattern CF1 and the second filter pattern CF2, and the third light shielding portion 223C is located between the second filter pattern CF2 and the third filter pattern CF3. The first light shielding portion 221C, the second light shielding portion 222C, and the third light shielding portion 223C are arranged along the first direction D1. In some embodiments, the first light shielding portion 221C, the second light shielding portion 222C, and the third light shielding portion 223C are each connected between two adjacent scan line shielding structures 230B.

In the embodiment, the transmittance of the scan line shielding structure 230B for visible light is different from the transmittance of the first light shielding portion 221C, the second light shielding portion 222C, and the third light shielding portion 223C for visible light.

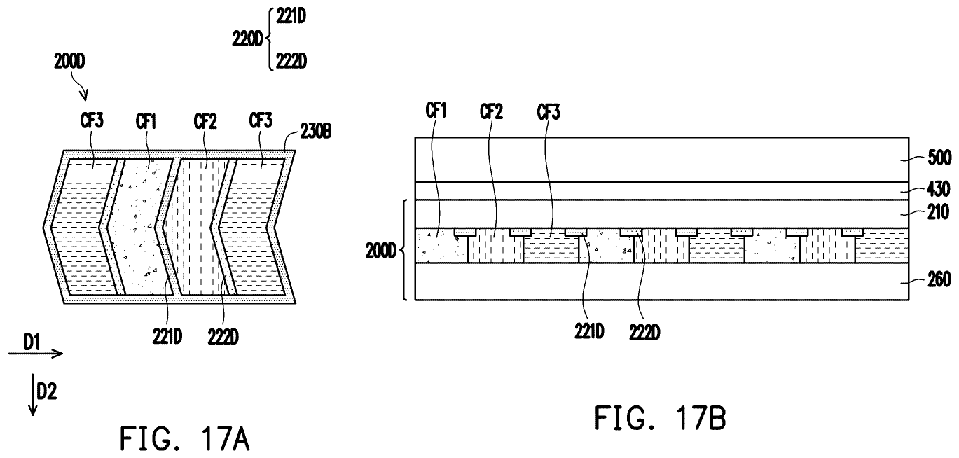

FIG. 17A is a partially enlarged top perspective view of a color filter substrate 200D of a display device according to an embodiment of the disclosure. FIG. 17B is a cross-sectional schematic view of the color filter substrate 200D of FIG. 17A and the second polarizing plate 430 and the cover plate 500 located thereon. It must be noted here that the embodiment of FIG. 17A and FIG. 17B continues to use the reference numerals and some content of the embodiment of FIG. 14, wherein the same or similar numerals are adopted to represent the same or similar elements, and the description of the same technical content is omitted. Reference may be made to the aforementioned embodiment for the description of the omitted part, which will not be reiterated here.

Please refer to FIG. 17A and FIG. 17B. In the embodiment, the data line (not shown) is substantially zigzag. Therefore, a part of the black matrix (not shown) of the color filter substrate 200D for shielding the data line and a sub-pixel separation structure 220D in the first display area also adopts the zigzag design.

In the embodiment, the sub-pixel separation structure 220D includes a first light shielding portion 221D and a second light shielding portion 222D. The first light shielding portion 221D and the second light shielding portion 222D include different materials. For example, the first light shielding portion 221D, the scan line shielding structure 230B, and the black matrix (not shown) include the same black light absorbing material, and the second light shielding portion 222D includes the infrared light filter pattern. Therefore, the transmittance of the second light shielding portion 222D for infrared light is greater than the transmittance of the first light shielding portion 221D for infrared light. In the embodiment, the transmittance of the scan line shielding structure 230B for visible light is different from the transmittance of the second light shielding portion 222D for visible light.

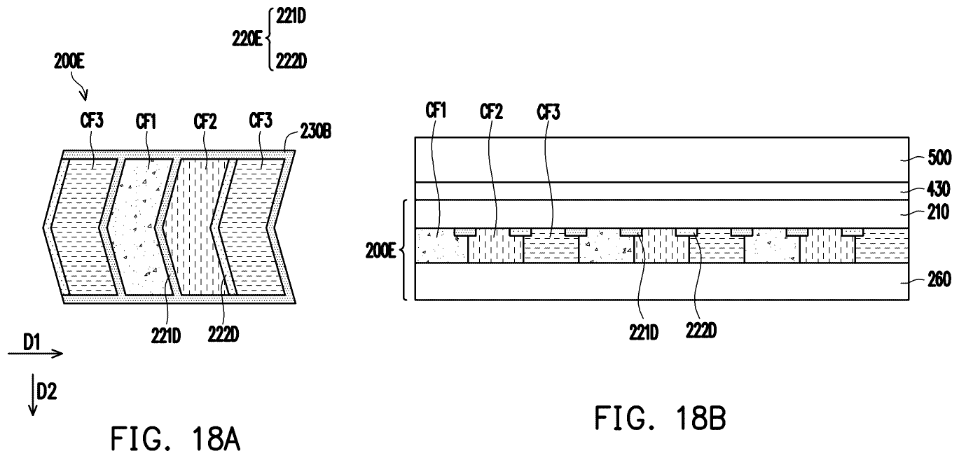

In the embodiment, the first light shielding portions 221D and the second light shielding portions 222D are alternately arranged in a 1-to-1 manner in the first direction D1, but the disclosure is not limited thereto. In other embodiments, the first light shielding portions 221D and the second light shielding portions 222D are alternately arranged in a multiple-to-1 manner (for example, 2-to-1) in the first direction D1, as shown in a sub-pixel separation structure 220E of a color filter substrate 200E of FIG. 18A and FIG. 18B. In the sub-pixel separation structure 220E of FIG. 18A and FIG. 18B, the second light shielding portion 222D is disposed between the second filter pattern CF2 (that is, the green filter pattern) and the third filter pattern CF3 (that is, the blue filter pattern), so as to filter out red light that may pass through the second light shielding portion 222D.

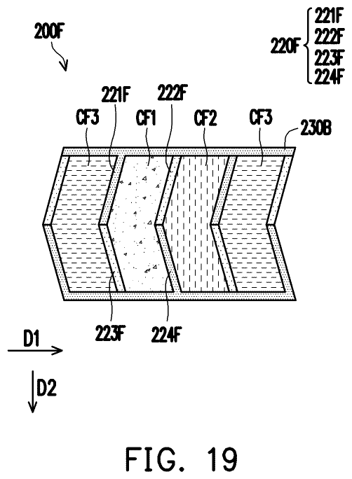

FIG. 19 is a partially enlarged top perspective view of a color filter substrate 200F of a display device according to an embodiment of the disclosure. It must be noted here that the embodiment of FIG. 19 continues to use the reference numerals and some content of the embodiment of FIG. 14, wherein the same or similar numerals are adopted to represent the same or similar elements, and the description of the same technical content is omitted. Reference may be made to the aforementioned embodiment for the description of the omitted part, which will not be reiterated here.

Please refer to FIG. 19. In the embodiment, the data line (not shown) is substantially zigzag. Therefore, a part of the black matrix (not shown) of the color filter substrate 200F for shielding the data line and a sub-pixel separation structure 220F also adopt the zigzag design.

In the embodiment, the sub-pixel separation structure 220F includes a first light shielding portion 221F, a second light shielding portion 222F, a third light shielding portion 223F, and a fourth light shielding portion 224F. In the embodiment, the first light shielding portion 221F, the fourth light shielding portion 224F, the scan line shielding structure 230B, and the black matrix include the same material (for example, the black light absorbing material), and the second light shielding portion 222F and the third light shielding portion 223F include the same material (for example, the infrared light filter pattern). The first light shielding portion 221F and the second light shielding portion 222F are arranged in the first direction D1, and the third light shielding portion 223F and the fourth light shielding portion 224F are also arranged in the first direction D1.

In the embodiment, each first light shielding portion 221F is located between the corresponding scan line shielding structure 230B and third light shielding portion 223F in the second direction D2, and each second light shielding portion 222F is located between the corresponding scan line shielding structure 230B and fourth light shielding portion 224F in the second direction D2. The first light shielding portion 221F, the second light shielding portion 222F, the third light shielding portion 223F, and the fourth light shielding portion 224F are located between two adjacent scan line shielding structures 230B in the second direction D2.

In the embodiment, the first light shielding portion 221F and the third light shielding portion 223F overlap with the same data line (not shown), and the second light shielding portion 222F and the fourth light shielding portion 224F overlap with another same data line (not shown).

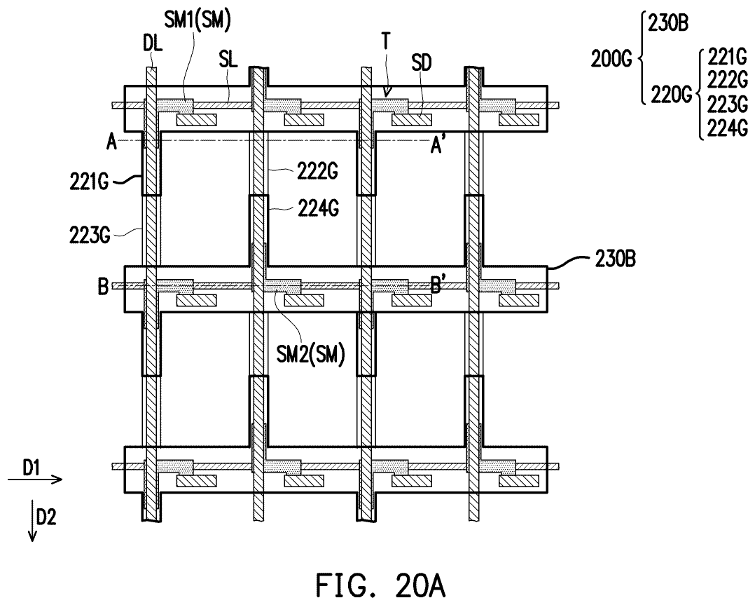

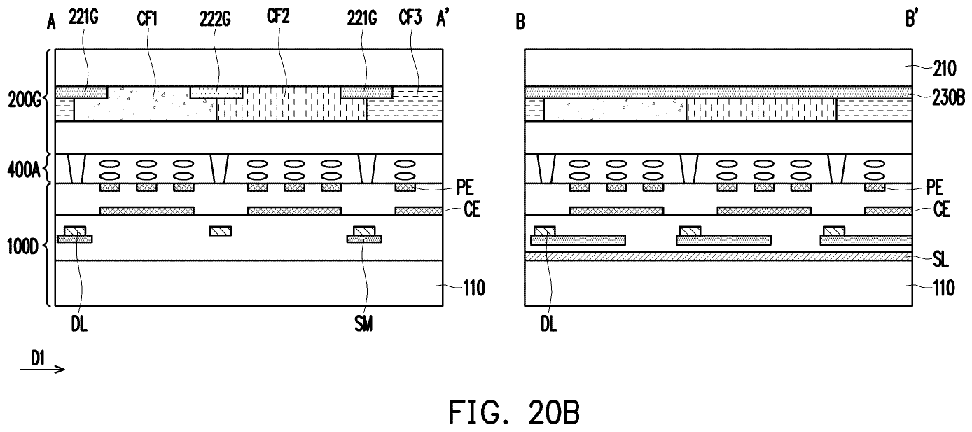

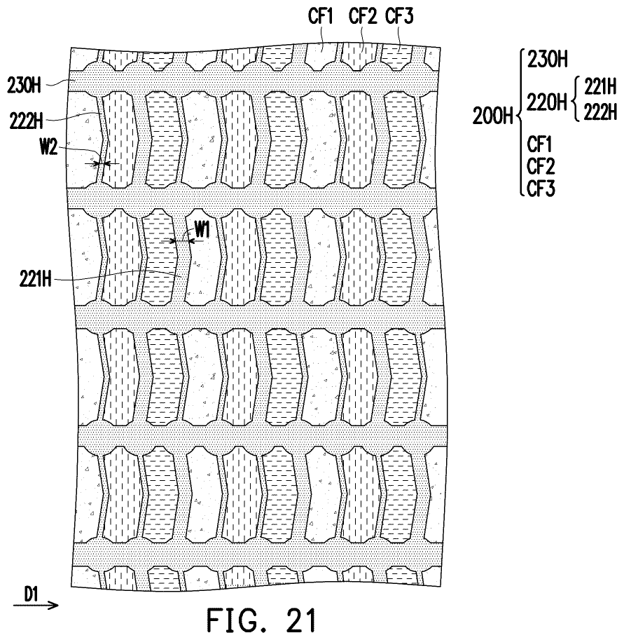

FIG. 20A is a partially enlarged top perspective view of a display device according to an embodiment of the disclosure. FIG. 20B is a cross-sectional schematic view along lines A-A′ and B-B′ of FIG. 20A. FIG. 20A shows a sub-pixel separation structure 220G and the scan line shielding structure 230B of a color filter substrate 200G, and the scan line SL, the data line DL, the semiconductor layer SM, and a source/drain SD of an active element of a pixel array substrate 100D, and other components are omitted. FIG. 20B shows the color filter substrate 200G, the pixel array substrate 100D, and the liquid crystal layer 400A located therebetween, and other components are omitted. It must be noted here that the embodiment of FIG. 20A and FIG. 20B continues to use the reference numerals and some content of the embodiment of FIG. 1 to FIG. 3B and the embodiment of FIG. 19, wherein the same or similar numerals are adopted to represent the same or similar elements, and the description of the same technical content is omitted. Reference may be made to the aforementioned embodiment for the description of the omitted part, which will not be reiterated here.

Please refer to FIG. 20A and FIG. 20B. The sub-pixel separation structure 220G includes a first light shielding portion 221G, a second light shielding portion 222G, a third light shielding portion 223G, and a fourth light shielding portion 224G. In the embodiment, the first light shielding portion 221G, the fourth light shielding portion 224G, the scan line shielding structure 230B, and the black matrix include the same material (for example, the black light absorbing material), and the second light shielding portion 222G and the third light shielding portion 223G include the same material (for example, the infrared light filter pattern). The first light shielding portion 221G and the second light shielding portion 222G are arranged in the first direction D1, and the third light shielding portion 223G and the fourth light shielding portion 224G are also arranged in the first direction D1.

In the embodiment, the first light shielding portion 221G and the third light shielding portion 223G overlap with the same data line DL, and the second light shielding portion 222G and the fourth light shielding portion 224G overlap with another same data line DL.

In the embodiment, the semiconductor layer SM includes different shape designs. For example, two ends of a semiconductor layer SM1 are located at the same side (the lower side in FIG. 20A) of the corresponding scan line SL and overlap with the first light shielding portion 221G and the source/drain SD, and two ends of a semiconductor layer SM2 are located on two opposite sides (the upper and lower sides in FIG. 20A) of the corresponding scan line SL and overlap with the fourth light shielding portion 221G and the source/drain SD.

The designs of the sub-pixel separation structure 220G and the semiconductor layer SM of the embodiment may provide more design spaces for the semiconductor layer SM while preventing light rays from irradiating the semiconductor layer SM. In addition, the semiconductor layer SM1 and the semiconductor layer SM2 with different shapes may reduce diffraction.

FIG. 21 is a partially enlarged top perspective view of a color filter substrate 200H of a display device according to an embodiment of the disclosure. It must be noted here that the embodiment of FIG. 21 continues to use the reference numerals and some content of the embodiment of FIG. 1 to FIG. 3B, wherein the same or similar numerals are adopted to represent the same or similar elements, and the description of the same technical content is omitted. Reference may be made to the aforementioned embodiment for the description of the omitted part, which will not be reiterated here.

Please refer to FIG. 21. The color filter substrate 200H includes the first filter area overlapping with the camera area of the pixel array substrate and the second filter area overlapping with the display area of the pixel array substrate. FIG. 21 is a partially enlarged top perspective view of the first filter area of the color filter substrate 200H.

The color filter substrate 200H includes multiple scan line shielding structures 230H and a sub-pixel separation structure 220H located in the first filter area. In some embodiments, the color filter substrate 200H further includes the black matrix (not shown in FIG. 21) located in the second filter area. Reference may be made to the aforementioned embodiment for the description of the black matrix, which will not be reiterated here.

In the embodiment, the scan line shielding structure 230H and the sub-pixel separation structure 220H include the same material, for example, both are the infrared light filter pattern. The scan line shielding structure 230H overlaps with the scan line of the pixel array substrate, and the sub-pixel separation structure 220H overlaps with the data line of the pixel array substrate.

The sub-pixel separation structure 220H includes multiple first light shielding portions 221H and multiple second light shielding portions 222H arranged in an array in the first direction D1 and the second direction D2. The width W1 of each first light shielding portion 221H in the first direction D1 is different from the width W2 of each second light shielding portion 222H in the first direction D1. In the embodiment, the width W1 of the first light shielding portion 221H in the first direction D1 is greater than the width W2 of the second light shielding portion 222H in the first direction D1.

In the embodiment, the camera module overlapping with the first filter area includes the infrared light sensing element, and the transmittance of the sub-pixel separation structure 220H and the scan line shielding structure 230H for infrared light is greater than the transmittance of the black matrix (such as including the black light absorbing material) for infrared light. Therefore, diffraction of infrared light in the first filter area may be prevented.

In the embodiment, the first light shielding portions 221H and the second light shielding portions 222H are alternately arranged in a 1-to-multiple (for example, 1-to-2) manner in the first direction D1, and the first light shielding portions 221H and the second light shielding portions 222H are alternately arranged in a 1-to-1 manner in the second direction D2. By alternately arranging the first light shielding portions 221H and the second light shielding portions 222H, the shape of the light emitting area and the periodicity of the sub-pixel may be changed, thereby reducing occurrence of diffraction.

In the embodiment, a part of the first light shielding portions 221H is located between the first color filter pattern CF1 and the third color filter pattern CF3, and another part of the first light shielding portions 221H is located between the second color filter pattern CF2 and the third color filter pattern CF3.

What is claimed is:

1. A display device, comprising:
a pixel array substrate, having a display area and a camera area, and comprising:
a plurality of scan lines, extending along a first direction;
a plurality of data lines, extending along a second direction not parallel to the first direction;
a plurality of display area sub-pixels, located in the display area; and
a plurality of camera area sub-pixels, located in the camera area;
a color filter substrate, comprising a first filter area overlapping with the camera area and a second filter area overlapping with the display area, wherein the color filter substrate comprises:
a plurality of scan line shielding structures, located in the first filter area and overlapping with the scan lines; and
a sub-pixel separation structure, located in the first filter area and overlapping with the data lines, wherein the sub-pixel separation structure comprises a first light shielding portion and a second light shielding portion arranged in the first direction, wherein transmittance of the scan line shielding structures for visible light is different from transmittance of the second light shielding portion for visible light; and
a camera module, wherein the camera area is located between the camera module and the first filter area.

2. The display device according to claim 1, wherein the color filter substrate comprises:
a first color filter pattern, a second color filter pattern, and a third color filter pattern, wherein the first light shielding portion is located between the first color filter pattern and the third color filter pattern in the first direction, and the second light shielding portion is located between the first color filter pattern and the second color filter pattern in the first direction.

3. The display device according to claim 2, wherein the first light shielding portion comprises:
a first bottom layer; and
a first cover layer, overlapping with the first bottom layer, wherein one of the first bottom layer and the first cover layer has a same material as and is integrally connected to the first color filter pattern, and other one of the first bottom layer and the first cover layer has a same material as and is integrally connected to the third color filter pattern; and the second light shielding portion comprises:
a second bottom layer; and
a second cover layer, overlapping with the second bottom layer, wherein one of the second bottom layer and the second cover layer has a same material as and is integrally connected to the first color filter pattern, and other one of the second bottom layer and the second cover layer has a same material as and is integrally connected to the second color filter pattern, wherein transmittance of the first light shielding portion for visible light is different from transmittance of the second light shielding portion for visible light.

4. The display device according to claim 3, wherein a liquid crystal layer with a thickness o f H_{LC} is comprised between the pixel array substrate and the color filter substrate, and the color filter substrate comprises a protective layer with a thickness of H_{OC} covering the first color filter pattern, the second color filter pattern, and the third color filter pattern, wherein each of the camera area sub-pixels comprises a pixel electrode, a distance between the pixel electrodes of adjacent two of the camera area sub-pixels is D_{PE}, a width of the first light shielding portion in the first direction is L, and an included angle between a shortest virtual line between the pixel electrode of one of the camera area sub-pixels located below the first color filter pattern and a side wall of the first bottom layer and a normal line direction of a top surface of the first bottom layer is θ, wherein L>2×(H_{OC}+H_{LC})×tan θ−D_{PE}.

5. The display device according to claim 3, wherein each of the camera area sub-pixels comprises a pixel electrode, the pixel electrode of one of the camera area sub-pixels located below the first color filter pattern and the first cover layer are separated by a distance X2 in the first direction, and the pixel electrode of another one of the camera area sub-pixels located below the third color filter pattern and the first bottom layer are separated by a distance X1 in the first direction, wherein the distance X1 is not equal to the distance X2.

6. The display device according to claim 2, wherein each of the scan line shielding structures comprises:
a first filter layer; and
a second filter layer, overlapping with the first filter layer, wherein one of the first filter layer and the second filter layer has a same material as and is integrally connected to the first color filter pattern, and other one of the first filter layer and the second filter layer has a same material as and is integrally connected to the third color filter pattern.

7. The display device according to claim 2, wherein the sub-pixel separation structure further comprises a third light shielding portion, and the third light shielding portion comprises:
a third bottom layer; and
a third cover layer, overlapping with the third bottom layer, wherein one of the third bottom layer and the third cover layer has a same material as and is integrally connected to the second color filter pattern, and other one of the third bottom layer and the third cover layer has a same material as and is integrally connected to the third color filter pattern.

8. The display device according to claim 7, wherein a width of the first light shielding portion in the first direction is greater than a width of the second light shielding portion in the first direction and a width of the third light shielding portion in the first direction.

9. The display device according to claim 1, wherein the camera module comprises an infrared light sensing element.

10. The display device according to claim 1, wherein the first light shielding portion has a wavy edge.

11. The display device according to claim 1, wherein the second light shielding portion and the first light shielding portion comprise a same material.

12. The display device according to claim 1, wherein transmittance of the second light shielding portion for infrared light is greater than transmittance of the first light shielding portion for infrared light.

13. The display device according to claim 12, wherein the color filter substrate comprises a plurality of first light shielding portions and a plurality of second light shielding portions, wherein the first light shielding portions and the second light shielding portions are alternately arranged in a 1-to-1 or plurality-to-1 manner in the first direction.

14. The display device according to claim 12, wherein the color filter substrate comprises:
a red filter pattern, a green filter pattern, and a blue filter pattern, wherein the green filter pattern and the blue filter pattern extend to a top surface of the red filter pattern, and a top surface of the second light shielding portion overlaps with at least one of the green filter pattern and the blue filter pattern.

15. The display device according to claim 12, wherein the sub-pixel separation structure further comprises a third light shielding portion and a fourth light shielding portion arranged in the first direction, wherein the first light shielding portion, the fourth light shielding portion, and the scan line shielding structures comprise a same material, and the second light shielding portion and the third light shielding portion comprise a same material, wherein the first light shielding portion and the third light shielding portion overlap with a same one of the data lines, and the second light shielding portion and the fourth light shielding portion overlap with another same one of the data lines.

16. The display device according to claim 15, wherein the first light shielding portion, the second light shielding portion, the third light shielding portion, and the fourth light shielding portion are located between adjacent two of the scan line shielding structures in the second direction.

17. The display device according to claim 1, wherein the color filter substrate further comprises:
a black matrix, located in the second filter area and overlapping with the scan lines and the data lines in the display area.

18. A display device, comprising:
a pixel array substrate, having a display area and a camera area, and comprising:
a plurality of scan lines, extending along a first direction;
a plurality of data lines, extending along a second direction not parallel to the first direction;
a plurality of display area sub-pixels, located in the display area; and
a plurality of camera area sub-pixels, located in the camera area;
a color filter substrate, comprising a first filter area overlapping with the camera area and a second filter area overlapping with the display area, wherein the color filter substrate comprises:
a plurality of scan line shielding structures, located in the first filter area and overlapping with the scan lines;
a sub-pixel separation structure, located in the first filter area and overlapping with the data lines, wherein the sub-pixel separation structure comprises a plurality of first light shielding portions and a plurality of second light shielding portions arranged in an array in the first direction and the second direction, wherein a width of each of the first light shielding portions in the first direction is different from a width of each of the second light shielding portions in the first direction; and
a black matrix, located in the second filter area and overlapping with the scan lines and the data lines in the display area; and
a camera module, wherein the camera area is located between the camera module and the first filter area.

19. The display device according to claim 18, wherein the camera module comprises an infrared light sensing element, and transmittance of the sub-pixel separation structure and the scan line shielding structures for infrared light is greater than transmittance of the black matrix for infrared light.

20. The display device according to claim 18, wherein a width of each of the first light shielding portions is greater than a width of each of the second light shielding portions, the first light shielding portions and the second light shielding portions are alternately arranged in a 1-to-plural manner in the first direction, and the first light shielding portions and the second light shielding portions are alternately arranged in a 1-to-1 manner in the second direction.
